(19) United States
(12) Patent Application Publication
(10) Pub. No.: US 2009/0041089 A1
(43) Pub. Date: Feb. 12, 2009

(54) SHARED CORRELATOR FOR SIGNALS WITH DIFFERENT CHIP RATES AND CORRELATION METHOD THEREOF

(75) Inventors: Jhih-siang Jhang, Taipei City (TW); Chun-nan Chen, Taipei City (TW)

Correspondence Address: AUSTIN RAPP & HARDMAN, 15 WEST SOUTH TEMPLE, SUITE 900, SALT LAKE CITY, UT, 84101, US

(73) Assignee: MEDIATEK Inc., Hsin-Chu (TW)

(21) Appl. No.: 11/834,783

(22) Filed: Aug. 7, 2007

(51) Int. Cl. H04B 1/00

(52) U.S. Cl. 375/139; 375/E01.001

(57) ABSTRACT

Disclosed is a shared correlator for processing signals with different chip rates from respective channels. The shared correlator comprises a mode controller, a plurality of sub-correlators, a PRN code generator and a plurality of accumulators. The mode controller arranges channel allocations for respective IF signals down converted from the signals. The PRN code generator generates respective PRN codes for the respective IF signals according to the respective chip rates thereof. The sub-correlators perform correlation to the respective IF signals with the respective PRN codes to obtain respective correlating results. The accumulators accumulate the respective correlation results to obtain respective overall correlation gains of the respective IF signals according to the respective chip rates. Each sub-correlator comprises a plurality of correlator cells, correlating one IF signal with one PRN code corresponding thereto according to the chip rate of the IF signal.

### FIELD OF THE INVENTION

The present invention generally relates to a shared correlator supporting different kinds of signals with different chip rates, and more particularly to a shared correlator supporting CDMA based signals with different chip rates and a correlation method thereof.

### BACKGROUND OF THE INVENTION

CDMA (Code Division Multiple Access) based communication products become popular and widely used nowadays, such as GPS, 3 G, IS-95, CDMA2000, WCDMA and etc. Meanwhile, there is a more practical tendency to design a single communication product for supporting several kinds of transmission standards. However, respective correlators for processing signals of the respective transmission standards are necessary according to prior arts. This is because that different chip rates are employed in different CDMA based communication standards. Some communication products may provide a shared correlator (single correlator) for several kinds of transmission standards to reduce area occupied by the respective correlators. However, such communication products use concept of TDMA (Time Division Multiple Access) control to separate respective processing periods for the different CDMA based signals. In addition, the most important is that all these CDMA based signals are restricted to have the same chip rate. Otherwise, the TDMA control is not possible to be implemented for the aforesaid shared correlator of the communication product for the different CDMA based transmission standards.

Moreover, the TDMA control concept in the aforesaid communication production is even used to realize the capability to process different CDMA based signals having the same chip rate by the shared correlator (single correlator), the communication production still processes the signals of one transmission standard at one time. Even only little quantity of the signals is processed, the whole shared correlator (the single correlator) is necessary to be set active for processing the little quantity of the signals. The power consumption of such correlator usage cannot be reduced and such correlator usage is not efficient enough. Therefore, an over usage of power consumption is an issue which cannot be avoided.

Furthermore, for processing great quantity of the signals in a chip time, the shared correlator's (the single correlator's) chip rate has to be much higher than those of the signals. Taking an example of GPS, the chip rate of L1 signal is 1.023 Mcps and the shared correlator's (the single correlator's) chip rate is 1.023 Mcps. Four L1 signals of four SVs (Satellites) are tracked. For processing the four L1 signals of the four SVs by the conventional correlator of which the chip rate is 1.023 Mcps, it takes 1 second. For processing the four L1 signals of the four SVs respectively by four correlators, it can merely take ¼ second. If the period of processing the four L1 signals by the single shared correlator is desired to be shortened as ¼ second, the chip rate of the aforesaid conventional correlator (the single correlator) has to be raised up to 4.092 Mcps. The raising of the chip rate means increase of the load and power consumption for the single correlator. Even if the communication product for supporting only one aforesaid CDMA based communication standard, there are still many signals to be processed, not to mention for supporting several kinds of CDMA transmission standards, the signal quantity are all needed to be processed and may cause the chip rate of the single correlator to be raised up to ten times or greater. It is unrealistic to raise the chip rate of the single correlator as aforementioned. Furthermore, the restriction of having same chip rate for those CDMA based signals remains even using the aforesaid single correlator to process different CDMA based signals. Such communication production still cannot be employed to support different CDMA based communication standards having different chip rates.

Consequently, a shared correlator for processing signals with different chip rates can be developed to solve the aforesaid drawbacks of the prior arts.

### SUMMARY OF THE INVENTION

To solve the foregoing drawbacks in the prior art, it is an objective of the present invention to provide a shared correlator capable of processing signals with different chip rates from respective channels.

Another objective of the present invention is to provide a shared correlator occupying less area in circuitry to achieve microminiaturization, which is much more important today.

Another objective of the present invention is to provide a shared correlator comprising a plurality of sub-correlators that selectively employs a portion of the sub-correlators to perform correlation to the signals when the signals need to be tracked are fewer, in order to reduce power consumption.

The shared correlator according to the present invention comprises a mode controller, a plurality of sub-correlators and a plurality of accumulators. The mode controller arranges channel allocations for respective IF signals down converted from the signals according to the respective chip rates. The shared correlator further comprises a PRN code generator. The PRN code generator generates respective PRN codes for the respective IF signals according to the respective chip rates thereof. The sub-correlators perform correlation to the respective IF signals from the respective channels with the respective PRN codes to obtain respective correlating results. The accumulators are coupled to the respective sub-correlators and accumulate the respective correlation results to obtain respective overall correlation gains of the respective IF signals according to the respective chip rates. Each sub-correlator comprises a plurality of correlator cells, correlating the IF signals down converted from one signal with one PRN code corresponding thereto according to the chip rate of the IF signals.

The shared correlator further comprises a processor coupled to the accumulators. According to the received IF signals, the processor may process one of the overall correlation gains, to restore information carried by at least one of the signals. The signals with which the shared correlator of the present invention correlate are CDMA based signals.

The present invention also provides a correlation method for processing signals with different chip rates from respective channels. The method comprises steps below:

arranging channel allocations for respective IF signals down converted from the signals according to the respective chip rates;

performing correlation to the respective IF signals from the respective channels with respective PRN codes to obtain respective correlating results; and

accumulating the respective correlation results to obtain respective overall correlation gains of respective IF signals according to the respective chip rates.

Before the step of performing correlation, the present invention further comprises a step of generating the respective PRN codes for the respective IF signals according to the respective chip rates thereof.

Moreover, the present invention further comprises a step of processing at least one of the overall correlation gains for restoring information carried by at least one of the signals after the accumulating step.

Conclusively, the shared correlator of the present invention is capable of processing signals with different chip rates. In addition, the shared correlator occupies less area in circuitry. Moreover, the mode controller is capable of selectively employing a portion of the sub-correlators to perform correlation with the IF signals down converted from one signal to reduce power consumption than to employ all the correlators.

### BRIEF DESCRIPTION OF THE DRAWINGS

The foregoing aspects and many of the attendant advantages of this invention will become more readily appreciated as the same becomes better understood by referencing the following detailed descriptions, when taken in conjunction with the accompanying drawings, wherein:

FIG. 1 illustrates a functional block diagram showing a front-end of a shared CDMA receiver having a shared correlator according to the present invention, which supports different communications with respective chip rates;

FIG. 2 is a block diagram showing the shared correlator according to the present invention;

FIG. 3 schematically shows how the shared correlator processes GPS L1/L2 and Galileo E6 signals from respective channels allocated based on the respective chip rates, which respectively are multiples of 1.023 Mcps, according to a first embodiment of the present invention; and

FIG. 4 schematically shows how the shared correlator processes GPS L1/L2 and CDMA signals from respective channels based on the respective chip rates which respectively are multiples of 1.023 Mcps but only the chip rate corresponding to the CDMA based signal is 3.84 Mcps according to a second embodiment of the present invention.

FIG. 5 shows a circuit diagram of a correlator cell in every sub-correlator in the present invention.

### DETAILED DESCRIPTION OF THE PREFERRED EMBODIMENTS

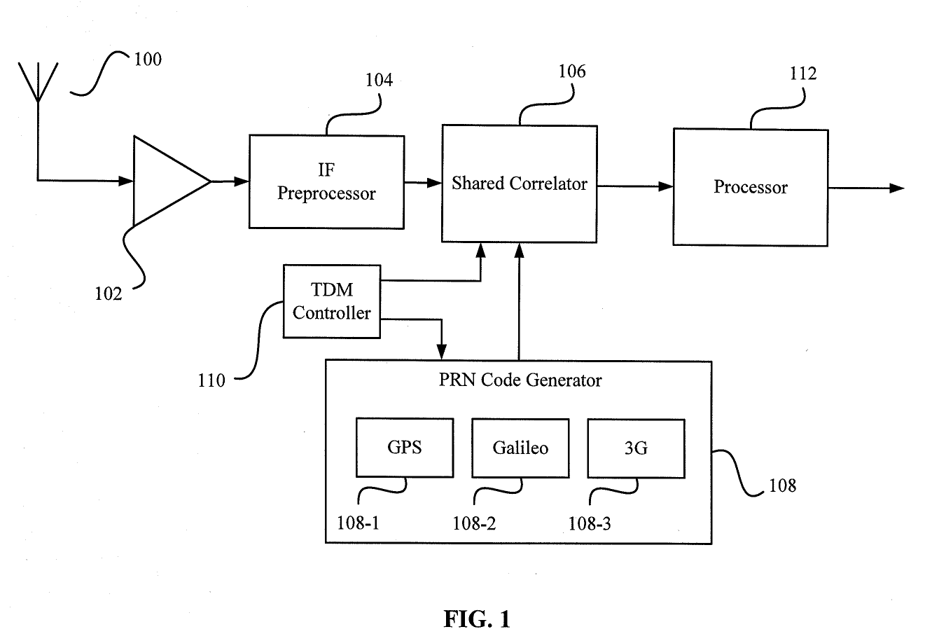

Please refer to FIG. 1, a front-end functional block diagram of a shared CDMA receiver having a shared correlator 106, which supports different signals with different chip rates according to the present invention. The CDMA receiver comprises an antenna 100, an amplifier 102, an IF preprocessor 104, the shared correlator 106, a PRN code generator 108, a TDM controller 110 and a processor 112. The antenna 100 receives various signals. The amplifier 102 amplifies the signals. The IF processor 104 down converts the signals into respective IF signals with respective chip rates. The shared correlator 106 processes the respective IF signals having respective chip rates for obtaining at least one of the overall correlation gains for the different signals with different chip rates. The explanation about the overall correlation gain will be described later. The PRN code generator 108 generates respective PRN codes for the respective IF signals according to the respective chip rates thereof. The TDM controller 110 arranges periods of correlating the respective IF signals with the respective PRN codes for the shared correlator 106. The shared correlator 106 processes at least one of the overall correlation gains for restoring information carried by at least one of the signals. Moreover, in the present embodiment, the PRN code generator 108 comprises a GPS PRN code generator 108-1, a Galileo PRN code generator 108-2 and a 3 G PRN code generator 108-3. However, these are not restricted by the present invention but depending on the design requirement of the shared CDMA receiver.

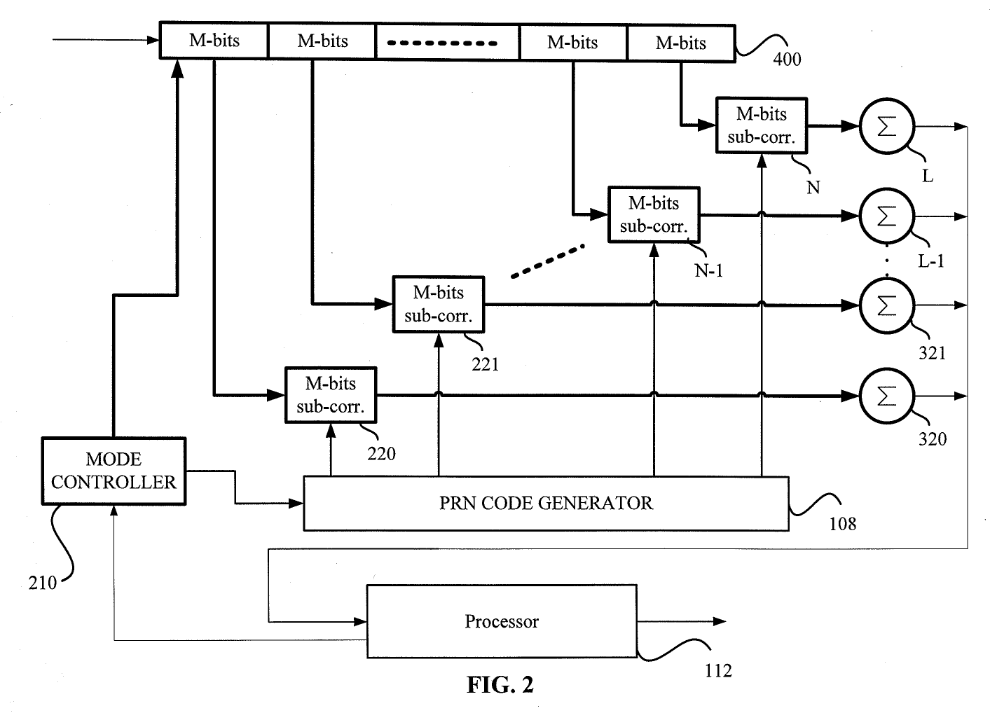

Please refer to FIG. 2, a diagram showing the shared correlator according to the present invention. The shared correlator 106 shown in FIG. 1 comprises a mode controller 210, a plurality of sub-correlators 220, 221, . . . N−1, N and a plurality of accumulators 320, 321, . . . L−1, L and a buffer 400. First, respective IF signals down converted from the signals received from the IF preprocessor 104 shown in FIG. 1 are stored in the buffer 400 according to the channel allocations arranged by the mode controller 210. For example, IF signals with M-bits chip rate allocated to the respective channels for the sub-correlators 220, 221, . . . N−1, N as shown in FIG. 2. In the present invention, the IF signals allocated to the respective channels have the same chip rate (M-bits). The IF signals also can have different chip rates M₁, M₂, . . . , Mₙ₋₁, Mₙ, respectively, and allocated to the respective channels for the sub-correlators 220, 221, . . . N−1, N. Some of the chip rates M₁, M₂, . . . , Mₙ₋₁, Mₙ also can be the same. The IF signals with M-bits chip rate down converted from the different signals are arranged into respective channel for transmission to the corresponding sub-correlators 220, 221, . . . N−1, N later. The PRN code generator 108 generates respective PRN codes for the sub-correlators 220, 221, . . . N−1, N. The accumulators 320, 321, . . . L−1, L are coupled to the sub-correlators 220, 221, . . . N−1, N respectively. The sub-correlators 220, 221, . . . N−1, N perform correlation to the respective IF signals with M-bits chip rate from the respective channels with the respective PRN codes to obtain respective correlation results. The accumulators 320, 321, . . . L−1, L accumulate the respective correlation results to obtain respective overall correlation gains of the respective IF signals according to the respective chip rates. The overall correlation gain is a summation obtained by accumulating all correlation results of the IF signals having the same chip rate. Basically, obtaining an overall correlation gain is a de-spread procedure for detecting a full signal power of the specific signal. Such de-spread procedure restores information carried by the specific spread spectrum signal. The spread spectrum procedure is mainly for security purpose and for reducing transmitting power according to the CDMA transmission standard. The processor 112 processes at least one of the overall correlation gains for restoring information carried by at least one of the signals.

Specifically, if only one signal is received to be correlated, for instance, the GPS L1 signals of four SVs are tracked, the mode controller 210 of the present invention arranges four channel allocations for the IF signals down converted from the GPS L1 signals from four SVs, and the IF signals are correlated respectively by four sub-correlators such as 220, 221, 223 and 224. The accumulators 320, 321, 322 and 324 accumulate the correlation results of the respective IF signals from the four sub-correlators, such as 220, 221, 223, 224 to obtain an overall correlation gain of the respective IF signals down converted from the GPS L1 signals. Accordingly, the other sub-correlators can be temporally set to idle to reduce power consumption of the CDMA receiver of the present invention. If IF signals down converted from other signals are received for correlation, the other idle sub-correlators can be started to correlate therewith. The mode controller 210 arranges preferred channel allocation for the respective IF signals down converted from other signals according to the respective chip rates.

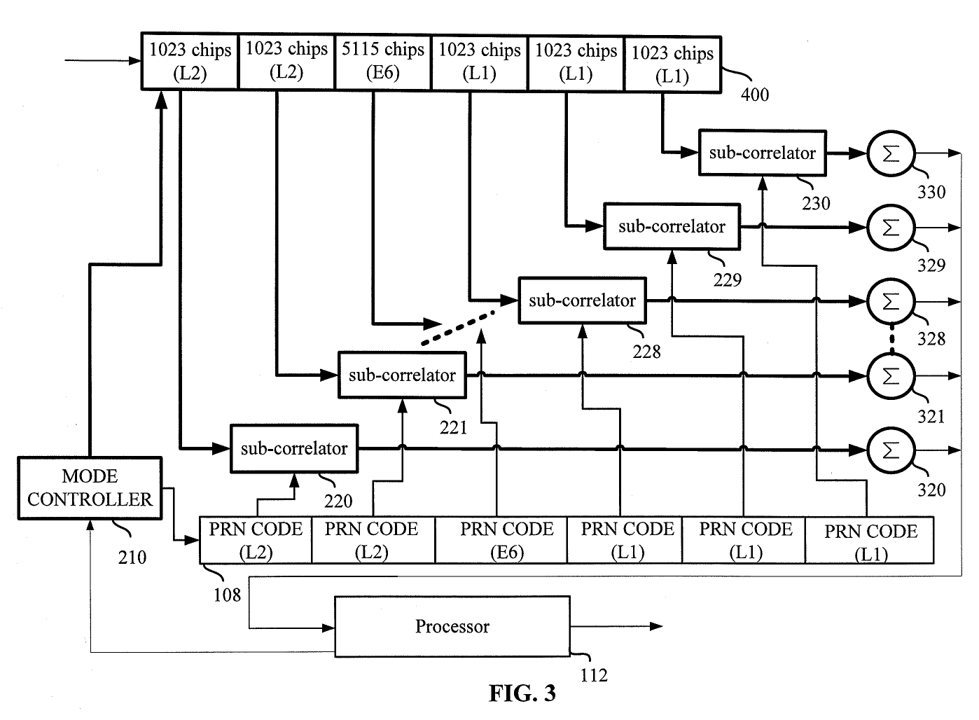

Please refer to FIG. 3. It schematically shows how the shared correlator processes GPS L1/L2 and Galileo E6 signals from respective channels allocated based on the respective chip rates, which respectively are multiples of 1.023 Mcps, according to a first embodiment of the present invention. In the first embodiment, the shared correlator 106 shown in FIG. 1 comprises a mode controller 210, ten sub-correlators 220, 221, . . . 229, 230 and ten accumulators 320, 321, . . . 329, 330 and a buffer 400. There are GPS L1 signal, GPS L2 signal and Galileo E6 signal down converted into respective IF signals by the IF preprocessor 104 shown in FIG. 1. The respective IF signals down converted from the GPS L1 signal, the GPS L2 signal and the Galileo E6 signal have respective chip rates: 1.023 Mcps of the GPS L1 signal, 1.023 Mcps of the GPS L2 signal and 5.115 Mcps of the Galileo E6 signal. Furthermore, there are three GPS L1 signals, two GPS L2 signals and one Galileo E6 signal are tracked. Accordingly, the mode controller 210 arranges corresponding channel allocation for the respective IF signals down converted from those signals. The respective IF signals down converted from the aforesaid three GPS L1 signals, two GPS L2 signals and one Galileo E6 signal are stored in the buffer 400 according to the channel allocation arranged by the mode controller 210.

Meanwhile, the PRN code generator 108 generates three GPS L1 PRN codes, two GPS L2 PRN codes and one Galileo E6 PRN code. Thereafter, the sub-correlators 220, 221 perform correlation to the IF signals down converted from two GPS L2 signals with the corresponding GPS L2 PRN codes. The sub-correlators 228, 229, 230 perform correlation to the IF signals down converted from three GPS L1 signals with the corresponding three GPS L1 PRN codes. The sub-correlators 222, 223, 224, 225, 226, 227 perform correlation to the IF signals down converted from the Galileo E6 signal with the corresponding Galileo E6 PRN code. Accordingly, the accumulators 320, 321 accumulate the correlation results from the sub-correlators 220, 221 to obtain an overall correlation gain of the IF signals down converted from the two GPS L2 signals. The accumulators 328, 329, 330 accumulate the correlation results from the sub-correlators 228, 229, 230 to obtain an overall correlation gain of the IF signals down converted from the three GPS L1 signals. The accumulators 322, 323, 324, 325, 326, 327 accumulate the correlation results from the sub-correlators 222, 223, 224, 225, 226, 227 to obtain an overall correlation gain of the IF signals down converted from the Galileo E6 signal At least one of the GPS L1 signal, the GPS L2 signal and the Galileo E6 signal (the spread-spectrum carrier signal) is de-spread and the full signal power is detected.

The processor 112 processes the overall correlation gains of the respective IF signals down converted from the GPS L1 signal, the GPS L2 signal and the Galileo E6 signal. According to the overall correlation gains of the respective IF signals, the processor 112 restores information carried by GPS L1 signal, the GPS L2 signal and the Galileo E6 signal.

Specifically, if only GPS L1 signal is received to be correlated, such as, GPS L1 signals of ten SVs are tracked. The mode controller 210 of the present invention can arrange ten channel allocations for the IF signals down converted from the GPS L1 signals from ten SVs and correlated by the ten sub-correlators 220, 221, . . . 229 and 230. Alternatively, the mode controller 210 also can arrange five channel allocations for IF signals down converted from the GPS L1 signals from ten SVs and correlated by the five sub-correlators 220, 221, 222, 223, 224 and 225. The mode controller 210 is capable of selectively employing only a portion of the sub-correlators to perform correlation with the IF signals down converted from the GPS L1 signal, the GPS L2 signal or the Galileo E6 signal and the other sub-correlators can be temporally set to idle to reduce power consumption. Similarly, ways of channel allocations can be predetermined for hundreds of situations related with receiving signals and the corresponding control modes of the mode controller 210 can be pre-programmed, pre-saved therein.

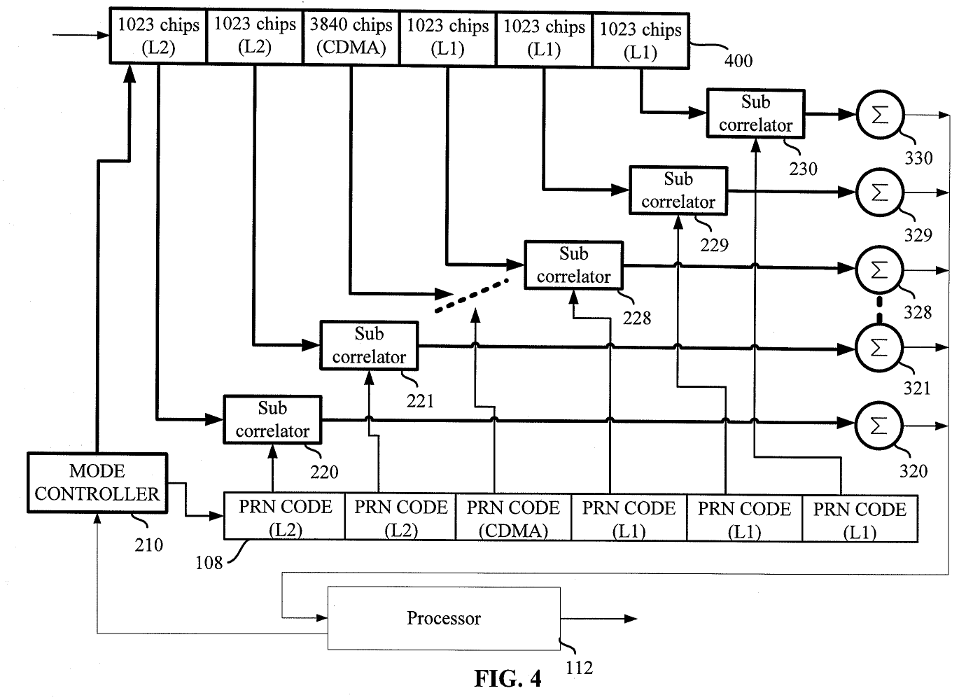

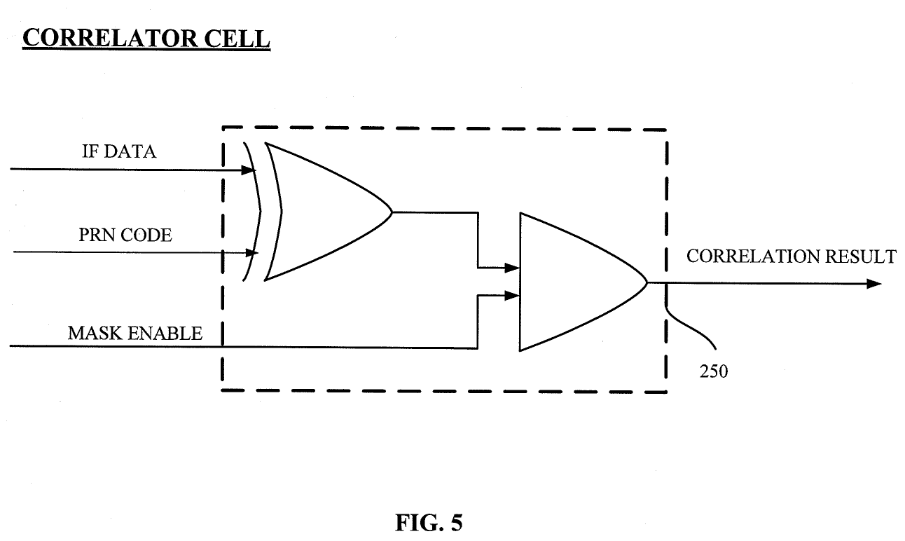

Please refer to FIG. 4 with FIG. 5. FIG. 4 schematically shows how the shared correlator processes GPS L1/L2 and CDMA based signals from respective channels based on the respective chip rates which respectively are multiples of 1.023 Mcps but only the chip rate corresponding to the CDMA based signal is 3.84 Mcps according to a second embodiment of the present invention. FIG. 5 shows a circuit diagram of a correlator cell 250 in every sub-correlator in the present invention. Same as in the first embodiment, the shared correlator 106 shown in FIG. 1 comprises a mode controller 210, ten sub-correlators 220, 221, . . . 229, 230 and ten accumulators 320, 321, . . . 329, 330 and a buffer 400. GPS L1 signal, GPS L2 signal and CDMA based signal are down converted into respective IF signals by the IF preprocessor 104 shown in FIG. 1. The respective IF signals down converted from the GPS L1 signal, the GPS L2 signal and the CDMA based signal. The GPS L1 signal has chip rates of 1.023 Mcps. The GPS L2 signal has chip rates of 1.023 Mcps. The CDMA based signal has chip rates of 3.84 Mcps.

In this embodiment, there are three GPS L1 signals, two GPS L2 signals and one CDMA based signal are tracked. Accordingly, the mode controller 210 arranges corresponding channel allocation for the respective IF signals down converted from those signals. The respective IF signals down converted from aforesaid three GPS L1 signals, two GPS L2 signals and the CDMA based signal are stored in the buffer 400 according to the channel allocation arranged by the mode controller 210. Meanwhile, the PRN code generator 108 generates three GPS L1 PRN codes, two GPS L2 PRN codes and the CDMA PRN code. Thereafter, the sub-correlators 220, 221 perform correlation to the IF signals down converted from two GPS L2 signals with the corresponding GPS L2 PRN codes. The sub-correlators 228, 229, 230 perform correlation to the IF signals down converted from three GPS L1 signals with the corresponding three GPS L1 PRN codes. The sub-correlators 222, 223, 224, 225, 226, 227 perform correlation to the IF signals down converted from the CDMA based signal with the corresponding CDMA PRN code.

Then, the accumulators 320, 321 accumulate the correlation results from the sub-correlators 220, 221 to obtain an overall correlation gain of the IF signals down converted from the two GPS L2 signals. The accumulators 328, 329, 330 accumulate the correlation results from the sub-correlators 228, 229, 230 to obtain an overall correlation gain of the IF signals down converted from the three GPS L1 signals. The accumulators 322, 323, 324, 325, 326, 327 accumulate the correlation results from the sub-correlators 222, 223, 224, 225, 226, 227 to obtain an overall correlation gain of the IF signals down converted from the CDMA based signal. At least one of the GPS L1 signal, the GPS L2 signal and the CDMA based signal (spread-spectrum carrier signal) is de-spread and the full signal power is detected.

The processor 112 processes the overall correlation gains of the respective IF signals down converted from the GPS L1 signal, the GPS L2 signal and the CDMA based signal. According to the overall correlation gains of the respective IF signals, the processor 112 restores information carried by GPS L1 signal, the GPS L2 signal and the CDMA based signal.

Similarly as described about the first embodiment, The mode controller 210 is capable of selectively employing only a portion of the sub-correlators to perform correlation with the IF signals down converted from the GPS L1 signal, the GPS L2 signal or the CDMA based signal and the other sub-correlators can be temporally set to idle to reduce power consumption.

More significantly, the chip rate of the CDMA based signal, 3.84 Mcps is not a multiple of the aforesaid 1.023 Mcps. Therefore, a mask function of each correlator cell can be employed for performing correlation to the IF signals having chip rate, which is 3.84 Mcps. The correlator cell 250 shown in FIG. 5 is a smallest unit inside every sub-correlator for comparing the IF signals with the PRN code to obtain a correlation result. With the mask function, the mode controller 210 can control the sub-correlator 222, 223, 224 and send a mask enable signal for selectively controlling a portion of the correlator cell with a specific proportion, which is calculated as [proportion=(3.84−1.023×3)÷0.023] inside the sub-correlator 225 to perform correlation to the IF signals down converted from the CDMA base signal with the CDMA PRN code corresponding thereto.

According to the shared correlator of the present invention, processing signals with different chip rates can be realized. Meanwhile, the area in the CDMA based communication product's circuitry, which the shared correlator occupies can be less than that which respective correlators prepared for respective signals with different chip rates occupies according to prior arts. Therefore, microminiaturization of CDMA based communication product (receiver) can be proceeded to the further. With using predetermined channel allocations for hundred situations related with receiving CDMA based signals but not always using one single correlator without other options like prior art, the power usage of the CDMA receiver can be more efficient.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A shared correlator for processing signals with different chip rates from respective channels, comprising:
a mode controller, arranging channel allocations for respective IF signals down converted from the signals according to the respective chip rates;
a plurality of sub-correlators, performing correlation to the respective IF signals from the respective channels to obtain respective correlating results; and
a plurality of accumulators, coupled to the respective sub-correlators, accumulating the respective correlation results to obtain respective overall correlation gains of the respective IF signals according to the respective chip rates.

2. The shared correlator of claim 1, further comprising a PRN code generator, generating respective PRN codes for the respective IF signals according to the respective chip rates thereof.

3. The shared correlator of claim 2, wherein the sub-correlators perform correlation to the respective IF signals from the respective channels with the respective PRN codes.

4. The shared correlator of claim 2, wherein the PRN code generator at least comprises a GPS PRN code generator, a Galileo PRN code generator and a 3 G PRN code generator.

5. The shared correlator of claim 1, further comprising a buffer, storing the respective IF signals according to the channel allocations arranged by the mode controller.

6. The shared correlator of claim 1, wherein the signals are CDMA based signals.

7. The shared correlator of claim 1, wherein each sub-correlator further comprises a plurality of correlator cells, correlating IF signals down converted from one signal with the PRN code corresponding thereto.

8. The shared correlator of claim 7, wherein the mode controller selectively controls a portion of the correlator cells in one sub-correlator to perform correlation to the IF signals down converted from the signal with the PRN code corresponding thereto according to a chip rate of the IF signals down converted from one signal.

9. The shared correlator of claim 1, further comprising a processor processing at least one of the overall correlation gains for restoring information carried by at least one of the signals.

10. A CDMA receiver capable of receiving signals with different chip rates, the CDMA receiver comprising:
an IF processor, down converting the signals into respective IF signals having respective chip rates;
a shared correlator, processing the respective IF signals according to the respective chip rates, further comprising:
a mode controller, arranging channel allocations for respective IF signals of the signals according to the respective chip rates;
a plurality of sub-correlators, performing correlation to the respective IF signals from the respective channels to obtain respective correlating results; and
a plurality of accumulators, coupled to the respective sub-correlators, accumulating the respective correlation results to obtain respective overall correlation gains of respective IF signals according to the respective chip rates.
a PRN code generator, generating respective PRN codes for the respective IF signals according to the respective chip rates thereof;
a TDM controller, arranging periods of correlating the respective IF signals with the respective PRN codes for the shared correlator; and
a processor, processing at least one of the overall correlation gains for restoring information carried by at least one of the signals.

11. The CDMA receiver of claim 10, wherein the sub-correlators perform correlation to the respective IF signals from the respective channels with the respective PRN codes.

12. The CDMA receiver of claim 10, wherein the PRN code generator at least comprises a GPS PRN code generator, a Galileo PRN code generator and a 3 G PRN code generator.

13. The CDMA receiver of claim 10, wherein the shared correlator further comprises a buffer, storing the respective IF signals according to the channel allocations from the mode controller.

14. The CDMA receiver of claim 10, wherein the signals are CDMA based signals.

15. The CDMA receiver of claim 10, each sub-correlator further comprises a plurality of correlator cells, correlating IF signals down converted from one signals with the PRN code corresponding thereto.

16. The CDMA receiver of claim 15, wherein the mode controller controls a portion of the correlator cells, correlating the IF signals down converted from the signal with the PRN code corresponding thereto according to a chip rate of the IF signals down converted from one signal.

17. A correlation method for processing signals with different chip rates from respective channels, the method comprising steps of:
arranging channel allocations for respective IF signals of the signals according to the respective chip rates;
performing correlation to the respective IF signals from the respective channels with respective PRN codes to obtain respective correlating results; and
accumulating the respective correlation results to obtain respective overall correlation gains of respective IF signals according to the respective chip rates.

18. The method of claim 17, further comprising a step of storing the respective IF signals according to the channel allocations from the mode controller before the arranging step.

19. The method of claim 17, further comprising a step of generating the respective PRN codes for the respective IF signals according to the respective chip rates thereof before the step of performing correlation.

20. The method of claim 17, further comprising a step of processing at least one of the overall correlation gains for restoring information carried by at least one of the signals after the accumulating step.
